(19) United States
(12) Patent Application Publication
(10) Pub. No.: US 2024/0405473 A1
(43) Pub. Date: Dec. 5, 2024

(54) Electrical Connector and Connector Assembly

(71) Applicant: Tyco Electronics (Shanghai) Co., Ltd., Shanghai (CN)

(72) Inventors: Yuchen Yang, Shanghai (CN); Tommy Qian, Shanghai (CN)

(73) Assignee: Tyco Electronics (Shanghai) Co., Ltd., Shanghai (CN)

(21) Appl. No.: 18/680,871

(22) Filed: May 31, 2024

(30) Foreign Application Priority Data
Jun. 2, 2023 (CN) 202321398461.X

(51) Int. Cl. H01R 13/502; H01R 13/10

(52) U.S. Cl. CPC H01R 13/502; H01R 13/10

(57) ABSTRACT

An electrical connector for mating with a mating connector includes a first connection terminal, an outer housing within which the first connection terminal is at least partially installed, and an inner housing at least partially arranged within the outer housing. The first connection terminal has a first end and a second end opposite the first end. The first end is electrically connectable to a mating end of a second connection terminal of the mating connector. The inner housing is rotatable relative to the outer housing. The first end of the first connection terminal is positioned within the inner housing and electrically contacts the mating end of the second connection terminal with the mating end rotatable relative to the first end.

### CROSS-REFERENCE TO RELATED APPLICATION

This application claims the benefit of the filing date under 35 U.S.C. § 119 (a)-(d) of Chinese Patent Application No. 202321398461.X, filed on Jun. 2, 2023.

### FIELD OF THE DISCLOSURE

Embodiments of the present disclosure generally relate to an electrical connector and a connector assembly.

### BACKGROUND OF THE INVENTION

Electrical connectors are commonly used to establish electrical connections between individual electronic components or devices, while high-voltage connectors are mainly used for vehicles, charging facilities, industrial equipment, medical equipment, etc. For example, with the development of electric or hybrid vehicles, their connection requirements are increasingly diversified, such as high voltage connections for charging a battery of the electric vehicle and for connecting the batteries to an electric motor, so as to provide a safe and reliable high voltage/high current connection between the power battery, power distribution unit, inverter, electric motor, charger, etc. of the vehicle.

The connection system of the electric vehicle needs to carry a very high current level, and especially during high-power charging or peak acceleration, the electric vehicles use high-voltage connectors for transmissions of currents at the level of 60V or higher and 10 A-300 A or higher. In high voltage applications, electrical connectors, such as a board-end connector electrically connected to a power supply such as a battery or a wire-end connector electrically connected to a cable, needs to have a finger protection function to avoid the risk of electric shock.

In addition, a physical space inside vehicle itself is limited, so those electrical connections also need to be optimized for compactness, weight, geometric flexibility, and cost. For example, as power supplies such as energy storage batteries become lightweight and miniaturized, the connectors required to be used are also miniaturized (e.g., with a reduced height). Further, due to the limited installation space inside the vehicle, the installation layout of the connector product and the harness avoidance space have posed challenges. Some conventional connector structures can usually only be mated with a mating connector at a fixed orientation or angle; changing of the installation orientation or position will interfere with the internal structure of the vehicle and is not convenient for installation.

### SUMMARY OF THE INVENTION

An electrical connector for mating with a mating connector includes a first connection terminal, an outer housing within which the first connection terminal is at least partially installed, and an inner housing at least partially arranged within the outer housing. The first connection terminal has a first end and a second end opposite the first end. The first end is electrically connectable to a mating end of a second connection terminal of the mating connector. The inner housing is rotatable relative to the outer housing. The first end of the first connection terminal is positioned within the inner housing and electrically contacts the mating end of the second connection terminal with the mating end rotatable relative to the first end.

### BRIEF DESCRIPTION OF THE DRAWINGS

Features and advantages of embodiments of the present disclosure will be apparent from the following description made in conjunction with the accompanying drawings, in which:

FIG. 1 is a perspective view schematically showing an overall configuration of a connector assembly according to an exemplary embodiment of the present disclosure;

FIG. 2 is an exploded perspective view schematically showing a structure of the connector assembly according to an exemplary embodiment of the present disclosure;

FIG. 3 is a top perspective view schematically showing a structure of an electrical connector according to an exemplary embodiment of the present disclosure;

FIG. 4 is an exploded perspective view schematically showing the structure of the electrical connector according to an exemplary embodiment of the present disclosure;

FIG. 5 is a bottom perspective view schematically showing the structure of the electrical connector according to an exemplary embodiment of the present disclosure;

FIG. 6 is a cross sectional view schematically showing the connector according to an exemplary embodiment of the present disclosure, taken along a line A-A shown in FIG. 3;

FIG. 7 is a cross sectional view schematically showing the connector according to an exemplary embodiment of the present disclosure, taken along a line B-B shown in FIG. 3;

FIG. 8 is a bottom perspective view schematically showing the structure of a mating connector of the connector assembly according to an exemplary embodiment of the present disclosure;

FIG. 9 is a cross sectional view schematically showing the mating connector according to an exemplary embodiment of the present disclosure, taken along a line C-C shown in FIG. 8;

FIG. 10 is a sectional view schematically showing a state of mating of a first connection terminal of the electrical connector to the mating connector of the connector assembly according to the exemplary embodiment of the present disclosure;

FIG. 11 is a perspective view schematically showing a state of mating of a second connection terminal of the mating connector to the electrical connector of the connector assembly according to the exemplary embodiment of the present disclosure; and

FIG. 12 is a perspective view schematically showing the mating state between connection terminals of the electrical connector and the mating connector of the connector assembly according to the exemplary embodiment of the present disclosure.

### DETAILED DESCRIPTION

Embodiments of the present disclosure will be described hereinafter in detail taken in conjunction with the accompanying drawings. In the description, the same or similar parts are indicated by the same or similar reference numerals. The description of each of the embodiments of the present disclosure hereinafter with reference to the accompanying drawings is intended to explain the general inventive concept of the present disclosure and should not be construed as a limitation on the present disclosure.

In addition, in the following detailed description, for the sake of explanation, numerous specific details are set forth to provide a thorough understanding of the disclosed embodiments. It will be apparent, however, that one or more embodiments may also be practiced without these specific details. In other instances, well-known structures and devices are illustrated schematically to simplify the drawing.

In the detailed description below, directional terms such as “front”, “back”, “up”, “down”, “left”, “right”, “upper” and “lower”, “inside” and “outside”, etc. are defined according to the accompanying drawings, but the shape and position of the parts are not limited by these terms and can be adjusted according to practical application.

In addition, the terms used herein are intended to describe exemplary embodiments and are not intended to limit and/or constrain the present disclosure. Unless the context expressly states otherwise, the singular forms “one”, “a” and “said” and “the” are also intended to include the plural form. In the present disclosure, the terms “include”, “comprise”, “have”, and similar terms are used to enumeration features, quantities, steps, operations, elements, parts, or combinations thereof, but do not exclude the presence or addition of one or more of such features, quantities, steps, operations, elements, parts, or combinations thereof.

Although the terms “first”, “second”, etc. may be used herein to describe a variety of different elements, these elements should not be restricted by these terms. These terms are used only to distinguish one element from another element. For example, without departing from the scope of the present disclosure, the first element may be referred to as the second element, and the second element may be referred to as the first element. The term “and/or” includes multiple combinations of associated items or any one of multiple associated items.

An electrical connector and a connector assembly including such electrical connector are provided according to exemplary embodiments of the present disclosure, for establishing electrical connections between various types of electronic components or devices, as shown in the figures. As an example, the electrical connector or connector assembly provided by the present disclosure can be used as a high voltage electrical connector in such fields as electric vehicles, hybrid electric vehicles, electric industrial equipment, medical equipment, charging facilities, etc., for example, used to provide a safe and reliable high voltage/high current connection between power battery, power distribution unit, power control unit, inverter, electric motor, charger and other electrical equipment of the vehicle.

In the exemplary embodiments as shown, the connector assembly includes an electrical connector 100 and a mating connector 200 capable of mating with each other. In the following text and drawings, description will be made by taking the electrical connector 100 as a socket connector suitable for being fixed (e.g., to an electrical equipment or its installation panel) and the mating connector 200 as a plug connector suitable for connecting a cable 1, but the present disclosure is not limited to this.

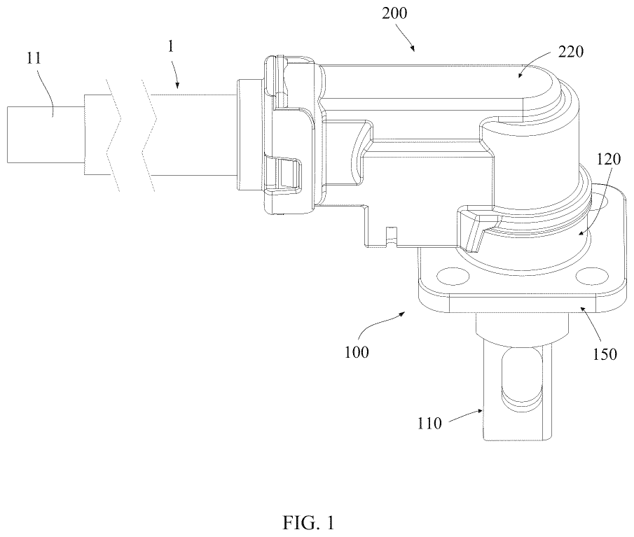

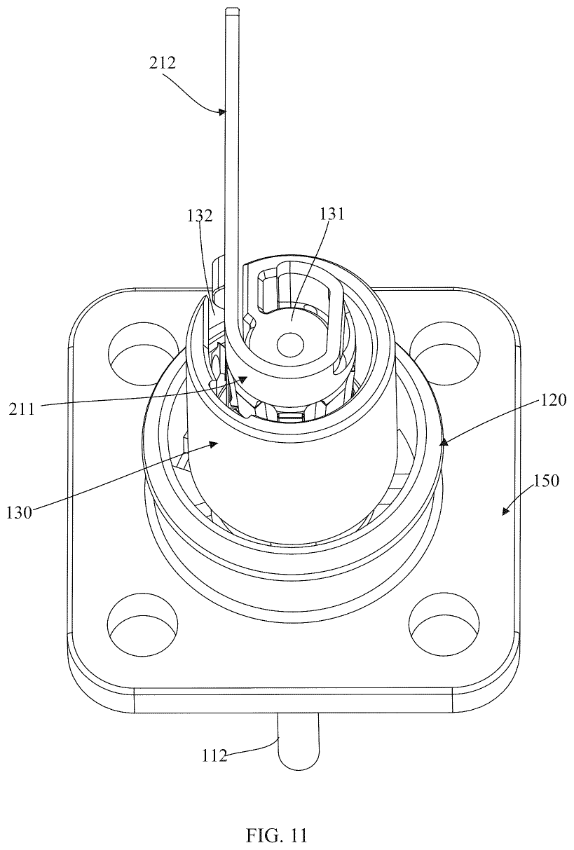

As shown in FIGS. 1-7 and 11, the electrical connector 100 includes a first connection terminal 110 and an outer housing 120. The outer housing 120 may be made of an insulating material such as plastic, and the first connection terminal 110 can be at least partially (e.g., detachable) installed in the outer housing 120 in a manner of being fixed or non-rotatable relative to the outer housing 120 and is used for power or signal transmission. As an example, the outer housing 120 may have a roughly cylindrical or polygonal profile. The first connection terminal 110 has a first end 111 and an opposite second end 112, and as described below, the first end 111 is used as a mating end for electrical connection (e.g., electrical contact) with a second connection terminal 210 of the mating connector 200. The second end 112 may be used as an installing end for being installed to or electrically connecting to an electrical equipment or its internal electronic component (such as a copper bar, a cable, a battery, a circuit board, etc.). For example, the mating connector 200 or its second connection terminal 210 may be inserted and mated to or separated from the electrical connector 100 in a first direction (namely the Z direction in the figure) as a mating direction.

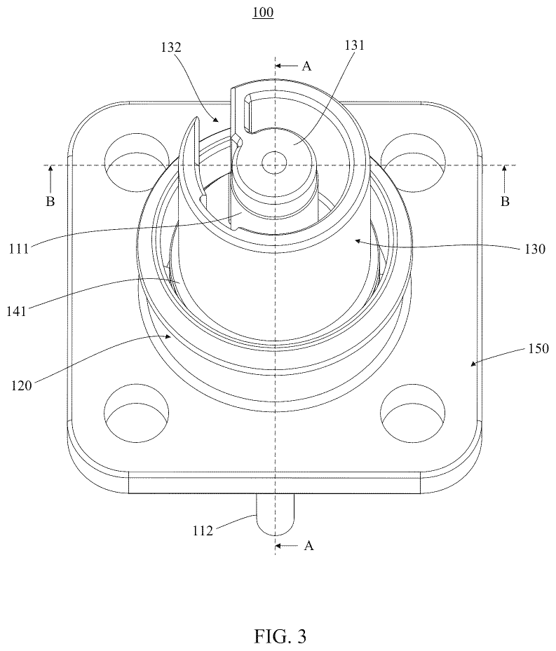

As an example, as shown in FIGS. 3, 4, and 6, the first end 111 of the first connection terminal 110 may have a solid cylinder or hollow cylindrical shape, so that the second connection terminal 210 of the mating connector 200 is rotatable relative to the first end 111 while being in contact with (e.g., being circumferentially slidable relative to) the first end 111, as described below. The shape of the second end 112 of the first connection terminal 110 is not particularly limited, and in the illustrated embodiments, has a roughly plate-like shape for being fixedly connected to the electrical equipment or its internal electronic component. It will be understood that in the present disclosure, unless expressly stated otherwise, an “end” of the connection terminal 110 as described is not limited to a tip or end point of the terminal, but may be a portion or section, with certain length suitable for electrical connection or electrical contact, of the terminal.

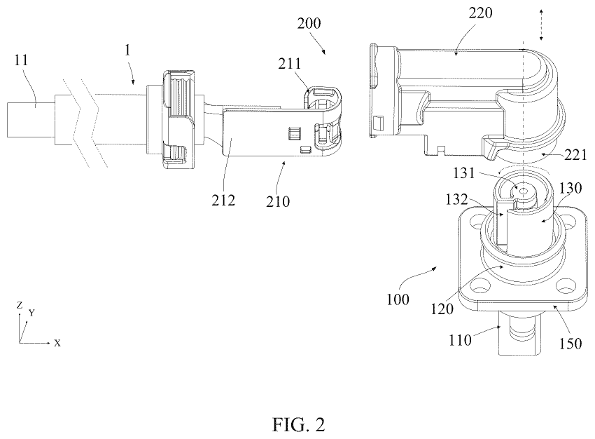

In an exemplary embodiment of the present disclosure, the electrical connector 100 also includes an insulating inner housing 130, as shown in FIGS. 2-7. The inner housing 130 is at least partially arranged within the outer housing 120 in a manner of being rotatable relative to the outer housing 120. The first end 111 of the first connection terminal 110 is positioned within the inner housing 130, as described below. The first end 111 may be configured and arranged to make an electrical contact with the mating end 211 of the second connection terminal 210 in a manner that the mating end 211 is allowed to be rotatable relative to the first end 111, thereby the inner housing 130 is rotatable together with the second connection terminal 210 relative to the first connection terminal 110 and the outer housing 120, such that the mating connector 200 is rotatable relative to the electrical connector 100 during mating.

According to the exemplary embodiments of the present disclosure, the first connection terminal 110 can be fixedly or non-rotationally positioned relative to the outer housing 120. Even if the second end 112 of the first connection terminal 110 has been installed to or electrically connected to the electrical equipment or its internal electronic component, the inner housing 130 of the electrical connector 100 and the second connection terminal 210 of the mating connector 200 are still rotatable relative to the first connection terminal 110 and the outer housing 120, which means that the mating connector 200 and electrical connector 100 can be mated or separated from different angles or orientations (e.g. in the range of 360)°. It is suitable for various installation scenarios and installation spaces and is easy to install or separate.

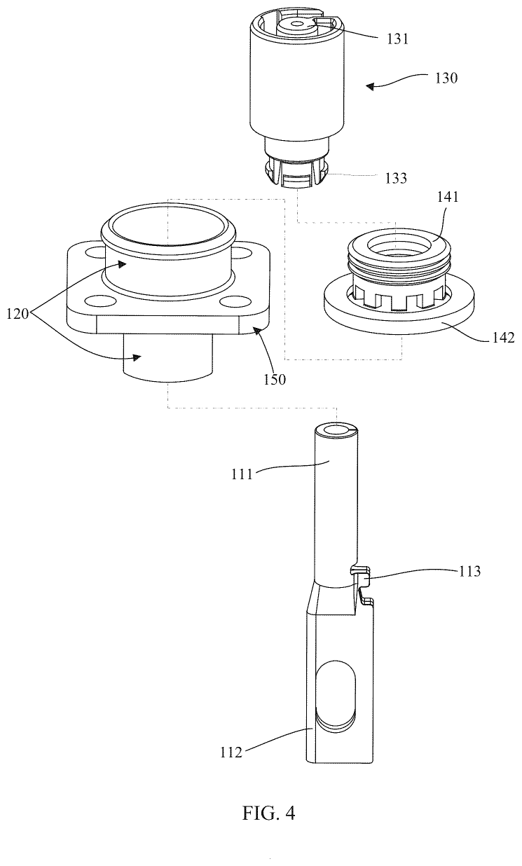

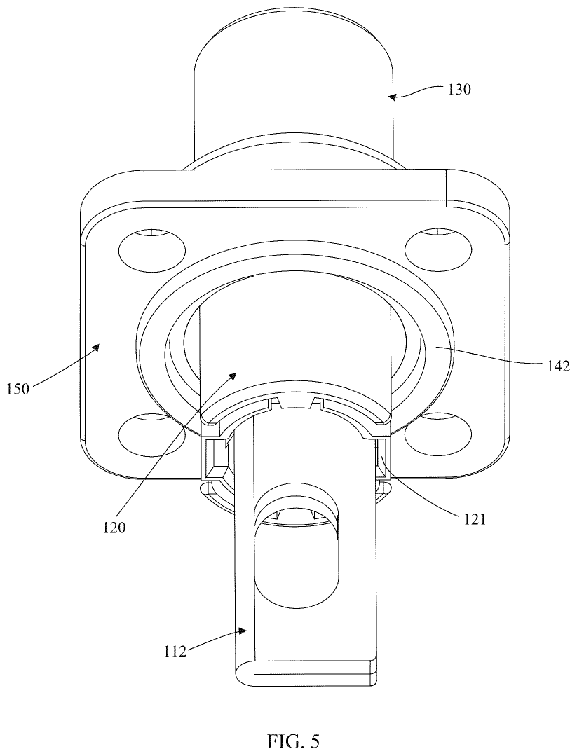

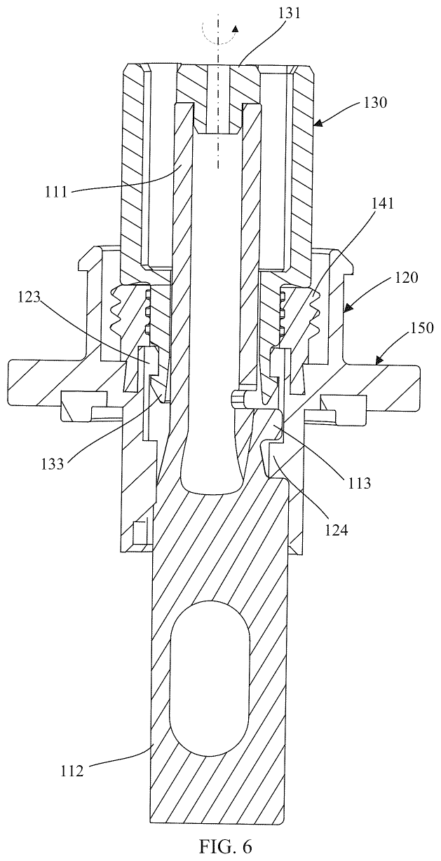

In some examples, as shown in FIG. 5, a groove 121 is formed in an inner wall surface of a side of the outer housing 120 and axially extends. A main body of the first connection terminal 110 between the first end 111 and the second end 112 can be caught into the groove 121 to prevent a rotation of the first connection terminal 110 relative to the outer housing 120. In other examples, the main body of the first connection terminal 110 may be formed with a groove, while the inner wall surface of the outer housing 120 may have a projection for being engaged with the groove to prevent the relative rotation therebetween. As shown in FIGS. 4 and 6, the main body of the first connection terminal 110 may be formed with a protrusion or flange 113 which engages a flange 124 formed on the inner wall surface of a side of the outer housing 120 to prevent the first connection terminal 110 from disengaging from the outer housing 120 in the axial direction (namely the Z direction in the figures). When the first connection terminal 110 needs to be removed or separated from the outer housing 120, the first connection terminal 110 may be pushed radially, so that the first connection terminal 110 is removed from the groove of the outer housing 120, and then, the protrusion or flange 113 is disengaged from the flange 124.

In the illustrated embodiments, as shown in FIGS. 3, 4, 6, and 7, the inner housing 130 may have a substantially hollow cylindrical body suitable for rotation relative to the outer housing 120, the hollow cylindrical body may extend in the first direction (namely the Z direction in the figures) to define a terminal accommodation space for accommodating at least the first end 111 of the first connection terminal 110. The inner housing 130 further has a first engagement portion extending from the hollow cylindrical body, and the first engagement portion is, for example, elastic or deflectable. A second engagement portion is formed on an inner wall of the outer housing 120, and the second engagement portion is configured to engage with the first engagement portion to prevent the inner housing 130 from separating from the outer housing 120 and to allow a rotation of the inner housing 130 relative to the outer housing 120.

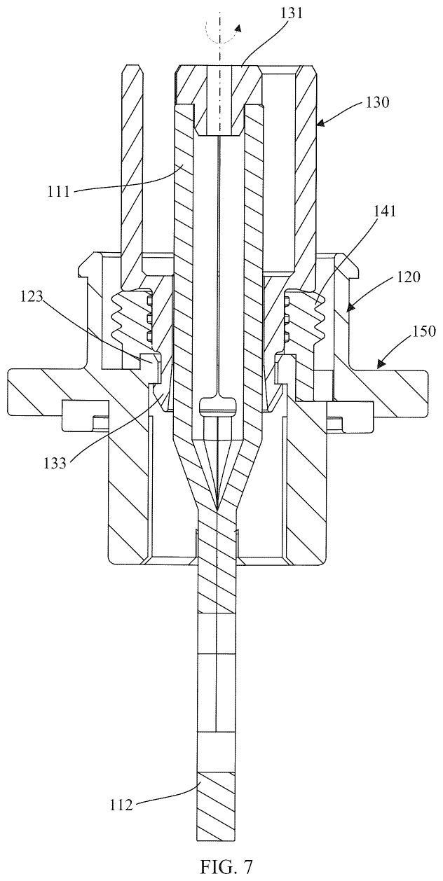

As an example, the first engagement portion may include a detent 133, shown in FIGS. 6 and 7, extending axially from the hollow cylindrical body and away from the first end 111, and the second engagement portion is an annular flange 123 protruding radially from the inner wall of the outer housing 120. In the assembled state, the detent 133 is snap fitted onto the annular flange 123, preventing the inner housing 130 from detaching from the outer housing 120 in the axial direction (namely Z direction in the figures), and the detent 133 can move (e.g. slide) along the annular flange 123, to guide the rotation of the inner housing 130 relative to the outer housing 120.

In some applications, the first connection terminal 110 of the electrical connector 100 is electrically connected to a high-voltage device such as a battery. The operator may mistakenly touch the first end 111 of the first connection terminal 110 exposed from the inner housing 130 while operating the connector assembly, resulting in a risk of electric shock. Therefore, in some embodiments of the present disclosure, as shown in FIGS. 2-4, 6-7, and 11, the electrical connector 100 or its inner housing 130 also includes an insulating first cover 131. The first cover 131 covers at least the end face of the first end 111, thus providing finger protection that prevents the operator's fingers from unintentionally touching the first connection terminal 110.

In an embodiment, the first cover 131 may extend radially inward from the hollow cylindrical body of the inner housing 130. For example, the first cover 131 extends integrally from the hollow cylindrical body or there is a connecting arm between the hollow cylindrical body and the first cover 131, and the first cover 131 can be positioned so that the first cover 131 is rotatable relative to the first end 111 of the first connection terminal 110. Thus, the first cover 131 can rotate together with the inner housing 130 relative to the first connection terminal 110 and the outer housing 120. In further embodiments, a gap between the first cover 131 and the outer housing 120 is sized to prevent the finger of a user from entering the inner housing 130 and contacting the first connection terminal 110 located in the terminal accommodation space (for example, during operation of mating with or detaching from the mating connector). For example, the size of the gap may be smaller than the size (e.g., width or thickness) of the finger in the direction perpendicular to the length of the finger, so that the finger cannot be in contact with the first connection terminal 110, thus providing finger protection or finger anti-contact function at the side of the electrical connector 100, thereby improving safety.

In some examples, as shown in FIGS. 3-4 and 6-7, a seal 141, such as a ring seal, may be installed between the inner housing 130 and the outer housing 120 to provide scaling and waterproofing function, for example, to prevent outside moisture from entering an inside of the electrical connector or electrical equipment.

As described above, the electrical connector 100 is suitable for being installed or fixed to an electrical equipment. In the illustrated embodiments, the electrical connector 100 may further include a flange part 150 suitable for being installed via fasteners onto an installation panel of the electrical equipment. The flange part 150 may extend (e.g., integrally) from the outer side wall of the outer housing 120 outward (e.g., vertically) into a flat plate or other shape suitable for installation. After assembly, the first end 111 of the first connection terminal 110 is located on one side or outside of the flange part 150, while the second end 112 is located on the opposite other side or inside of the flange part 150 for easy connection with the electrical equipment or its internal electronic component. The seal 142 may be arranged on the opposite other side or inside of the flange part 150 to create a waterproof seal between the electrical connector 100 and the installation panel of the electrical equipment.

In the embodiments of the present disclosure, the first connection terminal 110 of the electrical connector 100 and the second connection terminal 210 of the mating connector 200 make contact in such a manner that both of them are allowed to rotate relative to each other, thereby allowing adjustment of the installation orientation or position of the mating connector 200 relative to the electrical connector 100 for a variety of installation scenarios. In some examples, the outer circumferential or inner circumferential surface of the first end 111 of the first connection terminal 110 is adapted to make sliding contact with the mating end 211 of the second connection terminal 210 to allow the mating end 210 to rotate along the circumferential surface relative to the first end 111.

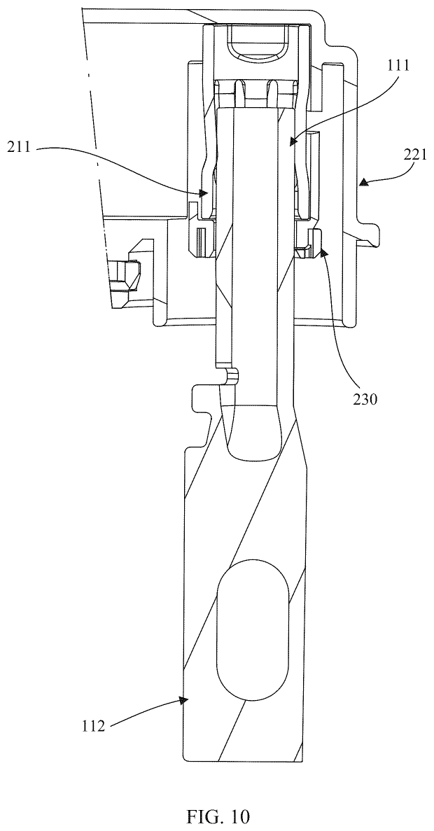

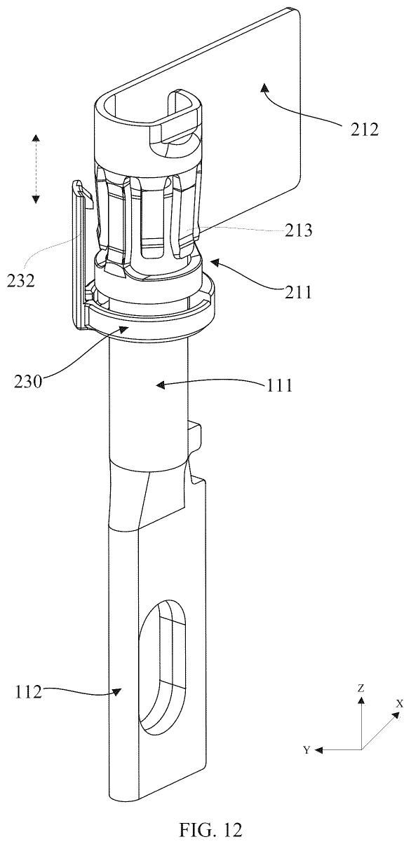

Shapes of the first connection terminal 110 of the electrical connector 100 and of the second connection terminal 210 of the mating connector 200 may be constructed in various ways, such that first connection terminal 110 and second connection terminal 210 are allowed to make rotatable contact therebetween. As an example, as shown in FIGS. 4-12, the first end 111 of the first connection terminal 110 may be a solid cylinder shape or hollow cylindrical shape, while the mating end 211 of the second connection terminal 210 has a hollow cylindrical shape, such that the first end 111 is allowed to be inserted into the hollow cylindrical mating end 211 in such a manner that the first end 111 is rotatable relative to the mating end 211 and is kept in contact with the mating end 211, thus the outer circumferential surface of the first end 111 makes contact with inner wall surface or inner circumferential surface of the mating end 211 in a relatively slidable or rotatable way. For example, the mating end 211 may include a plurality of clastic contact fingers arranged in a hollow cylindrical profile. In an alternative embodiment, the first end of the first connection terminal may have a hollow cylindrical shape, while the mating end of the second connection terminal may have a hollow cylindrical or solid cylinder shape, such that the mating end of the second connection terminal is allowed to be inserted into the first end in such a manner that the mating end of the second connection terminal is rotatable relative to the first end of the first connection terminal and is kept in contact with the first end, thus the outer circumferential surface of the mating end can make contact with inner wall surface or inner circumferential surface of the first end in a relatively slidable or rotatable way.

In the illustrated embodiments, an annular gap is defined within the terminal accommodation space defined by the inner housing 130 between the circumferential surface of the first end 111 of the first connection terminal 110 and the inner wall surface of the inner housing 130 and is configured for at least partially accommodating the mating end 211 of the second connection terminal 210, such that the mating end 211 with a hollow cylindrical shape is allowed to be inserted into the annular gap in such a manner that the mating end 211 makes a sliding contact with an outer circumferential surface of the first end 111 and is rotatable relative to the first end 111.

In some embodiments, as shown in FIGS. 2-4 and 11-12, the hollow cylindrical body of the inner housing 130 is formed with an open groove or slot 132 axially extending (in the Z direction in the figure), such that a portion (e.g., its main body) of the second connection terminal 210 is allowed to pass through the slot 132 so as to position the mating end 211 within the terminal accommodation space of the inner housing 130.

In a state where the mating connector 200 is mated in a plug-in way with the electrical connector 100, the second connection terminal 210 can be arranged to interfere with the inner housing 130 in a circumferential direction or a rotation direction, so that a shell 220 of the mating connector 200 can bring the inner housing 130 via the second connection terminal 210 to rotate relative to the outer housing 120 and the first connection terminal 110 of the electrical connector 120. For example, the main body and the second end 212 of the second connection terminal 210 may extend in a second direction (namely X direction in the figure) different from the first direction (namely Z direction in the figure), such that the portion of the second connection terminal 210 close to the mating end 211 may be positioned in the slot 132 which may be formed for example at a position near a connecting arm between the first cover 131 and the hollow cylindrical body, thus, the rotation of the second connection terminal 210 relative to the first connection terminal 110 can bring the inner housing 130 to rotate together.

As shown in FIGS. 1 and 2, the mating connector 200 includes the shell 220, and the second connection terminal 210 is installed within the shell 220 and is adapted to connect the cable 1 at the other end 212, such as being electrically connected to a core wire 11 of the cable 1. In some examples, the mating connector 200 may have a right-angle housing or be a right-angle plug, and its shell 220 may at least partially extend in a second direction different from the first direction so that the extension direction of the connected cable is different from the first direction, rendering the overall of the connector assembly in an elbow form to reduce the space (e.g., height) required for installation or to adapt to a narrow mounting space. In other examples, the mating connector 200 may also be a linear plug to adapt to different installation requirements.

In illustrated embodiments, as shown in FIGS. 1-2 and 8-10, the housing of the mating connector 200 is the right-angle housing and includes a hollow plug-in portion 221 extending in the first direction, the mating end 211 of the second connection terminal 210 is positioned at least partially in the plug-in portion 221, and the inner housing 130 of the electrical connector 100 is adapted to be positioned at least partially in the plug-in portion 221, such that the mating end 211 of the second connection terminal 210 makes an electrical contact with the first end 111 of the first connection terminal 110 and the shell 220 and the inner housing 130 are rotatable relative to the outer housing 120. Thus, the plug-in mating or separation of the mating connector 200 and the electrical connector 100 can be realized from different angles or directions (e.g., in the range of 360)°. It is suitable for various installation scenarios and installation spaces and is easy for installation or separation.

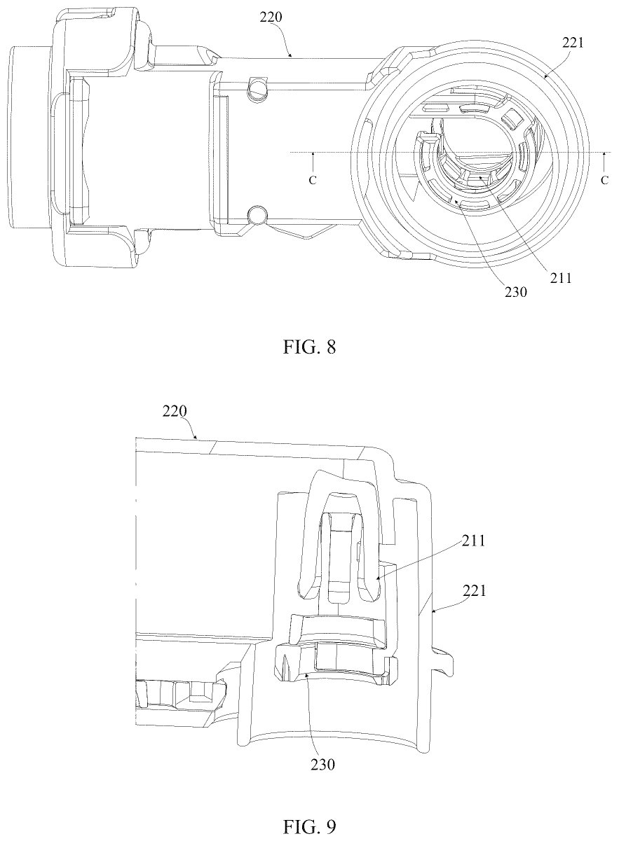

In some embodiments, as shown in FIGS. 8-12, the mating connector 200 may further include an insulating second cover 230 arranged within the plug-in portion 221 to partially cover an end face of the mating end 211 of the second connection terminal 210, thus providing finger protection or finger anti-contact function at the side of the mating connector 200, thereby improving safety. The second cover 230 may include a hollow or annular cover body and an elastic arm 232 extending axially from the cover body, and the second cover 230 may be connected inside the plug-in portion 221 in a snap-fit way.

Although embodiments of the present disclosure have been shown and described, it should be understood for those skilled in the art that these embodiments may be varied without departing from the principle and spirit of the present disclosure, and that the scope of protection of the present disclosure is limited by the attached claims and their equivalents. It should also be noted that, unless otherwise indicated, the words “include”, “comprise”, “have” as used herein do not exclude other elements or steps. In addition, the designation of any elements of the claims shall not be construed as limiting the scope of protection of the present disclosure.

What is claimed is:

1. An electrical connector for mating with a mating connector, comprising:
a first connection terminal having a first end and a second end opposite the first end, the first end is electrically connectable to a mating end of a second connection terminal of the mating connector;
an outer housing within which the first connection terminal is at least partially installed; and
an inner housing at least partially arranged within the outer housing, the inner housing is rotatable relative to the outer housing, the first end of the first connection terminal is positioned within the inner housing and electrically contacts the mating end of the second connection terminal with the mating end rotatable relative to the first end.

2. The electrical connector of claim 1, wherein the first connection terminal is fixedly positioned relative to the outer housing and the inner housing is rotatable relative to both the first connection terminal and the outer housing.

3. The electrical connector of claim 2, wherein the outer housing has a groove axially extending in an inner wall surface, the first connection terminal has a main body between the first end and the second end that fits into the groove to prevent rotation of the first connection terminal relative to the outer housing.

4. The electrical connector of claim 2, wherein the inner housing includes:
a cylindrical body that is hollow and defines a terminal accommodation space accommodating at least the first end of the first connection terminal; and
a first engagement portion extending from the cylindrical body, an inner wall of the outer housing has a second engagement portion engaging the first engagement portion to prevent the inner housing from separating from the outer housing and to permit rotation of the inner housing relative to the outer housing.

5. The electrical connector of claim 4, wherein the first engagement portion includes a detent extending axially from the cylindrical body and away from the first end, the second engagement portion includes an annular flange protruding radially from the inner wall of the outer housing.

6. The electrical connector of claim 4, wherein the inner housing has a first cover extending radially inward from the cylindrical body to cover an end face of the first end, the first cover is rotatable relative to the first end of the first connection terminal.

7. The electrical connector of claim 2, wherein the first end of the first connection terminal has a circumferential surface making a slidable contact with the mating end of the second connection terminal to allow rotation of the mating end along the circumferential surface relative to the first end.

8. The electrical connector of claim 3, wherein the first end of the first connection terminal has a circumferential surface making a slidable contact with the mating end of the second connection terminal to allow rotation of the mating end along the circumferential surface relative to the first end.

9. The electrical connector of claim 4, wherein the first end of the first connection terminal has a circumferential surface making a slidable contact with the mating end of the second connection terminal to allow rotation of the mating end along the circumferential surface relative to the first end.

10. The electrical connector of claim 5, wherein the first end of the first connection terminal has a circumferential surface making a slidable contact with the mating end of the second connection terminal to allow rotation of the mating end along the circumferential surface relative to the first end.

11. The electrical connector of claim 6, wherein the first end of the first connection terminal has a circumferential surface making a slidable contact with the mating end of the second connection terminal to allow rotation of the mating end along the circumferential surface relative to the first end.

12. The electrical connector of claim 7, wherein
the first end of the first connection terminal has a solid cylindrical shape or a hollow cylindrical shape, the first end is insertable into the mating end of the second connection terminal and is rotatable relative to the mating end while in contact with the mating end; or
the first end of the first connection terminal has a hollow cylindrical shape and the mating end of the second connection terminal is insertable into the first end with the mating end rotatable relative to the first end while in contact with the first end.

13. The electrical connector of claim 7, wherein an annular gap is defined within a terminal accommodation space between the circumferential surface of the first end and an inner wall surface of the inner housing, the annular gap at least partially accommodates the mating end of the second connection terminal, the mating end with a hollow cylindrical shape is insertable into the annular gap with the mating end making a slidable contact with an outer circumferential surface of the first end and rotatable relative to the first end.

14. The electrical connector of claim 4, wherein the cylindrical body has an axially extending slot, a portion of the second connection terminal passes through the slot to position the mating end within the terminal accommodation space.

15. A connector assembly, comprising:
an electrical connector including a first connection terminal having a first end and a second end opposite the first end, an outer housing within which the first connection terminal is at least partially installed, and an inner housing at least partially arranged within the outer housing, the inner housing is rotatable relative to the outer housing, the first end of the first connection terminal is positioned within the inner housing; and
a mating connector matable with the electrical connector in a first direction, the first end of the first connection terminal is electrically connectable to a mating end of a second connection terminal of the mating connector, the first end electrically contacts the mating end of the second connection terminal with the mating end rotatable relative to the first end.

16. The connector assembly of claim 15, wherein the mating connector has a shell within which the second connection terminal is installed, the second connection terminal is connectable to a cable.

17. The connector assembly of claim 16, wherein the shell extends at least partially in a second direction different from the first direction, an extension direction of the cable is different from the first direction.

18. The connector assembly of claim 16, wherein the shell has a hollow plug-in portion extending in the first direction, the mating end of the second connection terminal is positioned at least partially in the hollow plug-in portion, the inner housing is positionable at least partially in the hollow plug-in portion with the mating end of the second connection terminal in electrical contact with the first end of the first connection terminal and the shell and the inner housing rotatable together relative to the outer housing.

19. The connector assembly of claim 18, wherein, in a state in which the mating connector is mated with the electrical connector, the second connection terminal interferes with the inner housing in a circumferential direction, and the shell moves the inner housing via the second connection terminal to rotate relative to the outer housing of the electrical connector.

20. The connector assembly of claim 18, wherein the mating connector includes an insulating second cover arranged within the hollow plug-in portion to partially cover an end face of the mating end.
